(19) United States
(12) Patent Application Publication
(10) Pub. No.: US 2019/0339370 A1
(43) Pub. Date: Nov. 7, 2019

(54) ULTRASONIC APPARATUS

(71) Applicant: Murata Manufacturing Co., Ltd., Nagaokakyo-shi (JP)

(72) Inventors: Kosuke WATANABE, Nagaokakyo-shi (JP); Motoyasu NAKAO, Nagaokakyo-shi (JP)

(21) Appl. No.: 16/512,426

(22) Filed: Jul. 16, 2019

Related U.S. Application Data
(63) Continuation of application No. PCT/JP2018/000268, filed on Jan. 10, 2018.

(30) Foreign Application Priority Data
Jan. 25, 2017 (JP) 2017-011157

(51) Int. Cl. G01S 7/52; H04R 3/00; H04B 1/26; H04B 11/00

(52) U.S. Cl. CPC G01S 7/52004; H04R 3/00; G01S 2007/52009; H04B 11/00; H04B 1/26

(57) ABSTRACT

An ultrasonic apparatus includes an ultrasonic transducer, a driving circuit, a receiving circuit, a frequency detector, a frequency storage, a temperature detector, and an anomaly determiner. The frequency detector detects a resonant frequency of the ultrasonic transducer. The frequency storage stores a resonant frequency of the ultrasonic transducer at a predetermined temperature. The anomaly determiner determines an anomaly of the ultrasonic transducer based on a temperature detected by the temperature detector, a resonant frequency stored in the frequency storage, and a resonant frequency detected by the frequency detector.

### CROSS REFERENCE TO RELATED APPLICATIONS

This application claims the benefit of priority to Japanese Patent Application No. 2017-011157 filed on Jan. 25, 2017 and is a Continuation Application of PCT Application No. PCT/JP2018/000268 filed on Jan. 10, 2018. The entire contents of each application are hereby incorporated herein by reference.

### BACKGROUND OF THE INVENTION

### 1. Field of the Invention

The present invention relates to an ultrasonic apparatus, and particularly, to an ultrasonic apparatus capable of detecting anomalies of an ultrasonic transducer included therein.

### 2. Description of the Related Art

Ultrasonic apparatuses are used in practice, in which an ultrasonic transducer transmits ultrasonic waves, receives reflected waves from an object to be detected, and thereby measures, for example, a distance to the object to be detected.

If a foreign substance, such as mud, adheres to the vibrating surface of the ultrasonic transducer, or if water droplets adhering to the vibrating surface freeze, the ultrasonic transducer is unable to transmit and receive waves. This leads to failure in the detection of an obstacle existing in front of the ultrasonic transducer.

Japanese Patent No. 2998232 discloses an ultrasonic sensor that is capable of detecting adhesion of a foreign substance, such as mud. This ultrasonic sensor detects the resonant frequency of an ultrasonic vibrator, monitors and compares the resonant frequency with the natural frequency, and thereby detects an anomaly in the operation of the ultrasonic vibrator.

The resonant frequency changes as the temperature changes. Therefore, with an anomaly detecting method which involves using a measured resonant frequency alone, it may be difficult to distinguish between an anomaly and a temperature change.

### SUMMARY OF THE INVENTION

Preferred embodiments of the present invention provide ultrasonic apparatuses that are each capable of accurately detecting anomalies of an ultrasonic transducer.

An ultrasonic apparatus according to a preferred embodiment of the present invention includes an ultrasonic transducer, a driving circuit, a receiving circuit, a frequency detector, a storage, a temperature detector, and a determiner. The driving circuit causes the ultrasonic transducer to transmit sonic waves. The receiving circuit receives sonic waves received by the ultrasonic transducer. The frequency detector detects a resonant frequency of the ultrasonic transducer. The storage stores a resonant frequency of the ultrasonic transducer at a predetermined temperature. The determiner determines an anomaly of the ultrasonic transducer based on a temperature detected by the temperature detector, the resonant frequency stored in the storage, and the resonant frequency detected by the frequency detector.

An ultrasonic apparatus according to a preferred embodiment of the present invention includes an ultrasonic transducer; a driving circuit to cause the ultrasonic transducer to transmit sonic waves; a receiving circuit to receive sonic waves received by the ultrasonic transducer; a Q-factor detector to detect a Q factor of the ultrasonic transducer; a storage to store a Q factor of the ultrasonic transducer at a predetermined temperature; a temperature detector; and a determiner to determine an anomaly of the ultrasonic transducer based on a temperature detected by the temperature detector, the Q factor stored in the storage, and the Q factor detected by the Q-factor detector.

An ultrasonic apparatus according to a preferred embodiment of the present invention includes an ultrasonic transducer; a driving circuit to cause the ultrasonic transducer to transmit sonic waves; a receiving circuit to receive sonic waves received by the ultrasonic transducer; a frequency detector to detect a resonant frequency of the ultrasonic transducer; a first storage to store a resonant frequency of the ultrasonic transducer at a predetermined temperature; a Q-factor detector to detect a Q factor of the ultrasonic transducer; a second storage to store a Q factor of the ultrasonic transducer at the predetermined temperature; a temperature detector; and a determiner to determine an anomaly of the ultrasonic transducer based on a temperature detected by the temperature detector, the resonant frequency stored in the first storage, the resonant frequency detected by the frequency detector, the Q factor stored in the second storage, and the Q factor detected by the Q-factor detector.

The determiner preferably includes a resonant frequency estimator to estimate a resonant frequency at the temperature detected by the temperature detector, based on the resonant frequency stored in the first storage; a first determination processor to determine whether the resonant frequency detected by the frequency detector is normal, based on the resonant frequency estimated by the resonant frequency estimator; a Q-factor estimator to estimate a Q factor at the temperature detected by the temperature detector, based on the Q factor stored in the second storage; and a second determination processor to determine whether the Q factor detected by the Q-factor detector is normal, based on the Q factor estimated by the Q-factor estimator.

The determiner preferably includes a resonant frequency estimator to estimate a resonant frequency at the temperature detected by the temperature detector, based on the resonant frequency stored in the first storage; a Q-factor estimator to estimate a Q factor at the temperature detected by the temperature detector, based on the Q factor stored in the second storage; and an anomaly determiner to determine whether the ultrasonic transducer is normal, based on a combination of the resonant frequency estimated by the resonant frequency estimator and the Q factor estimated by the Q-factor estimator.

The temperature detector preferably includes a capacitance detector to detect a capacitance of the ultrasonic transducer; a capacitance storage to store a capacitance of the ultrasonic transducer at the predetermined temperature; and a temperature estimator to estimate a temperature based on the capacitance detected by the capacitance detector and the capacitance stored by the capacitance storage.

An ultrasonic apparatus according to a preferred embodiment of the present invention includes an ultrasonic transducer; a driving circuit to cause the ultrasonic transducer to transmit sonic waves; a receiving circuit to receive sonic waves received by the ultrasonic transducer; a Q-factor detector to detect a Q factor of the ultrasonic transducer; a storage to store a Q factor of the ultrasonic transducer at a predetermined temperature; a capacitance detector to detect a capacitance of the ultrasonic transducer; a capacitance storage to store a capacitance of the ultrasonic transducer at the predetermined temperature; and a determiner to determine an anomaly of the ultrasonic transducer based on the capacitance detected by the capacitance detector, the Q factor stored in the storage, and the Q factor detected by the Q-factor detector.

An ultrasonic apparatus according to a preferred embodiment of the present invention includes an ultrasonic transducer; a driving circuit to cause the ultrasonic transducer to transmit sonic waves; a receiving circuit to receive sonic waves received by the ultrasonic transducer; a frequency detector to detect a resonant frequency of the ultrasonic transducer; a storage to store a resonant frequency of the ultrasonic transducer at a predetermined temperature; a capacitance detector to detect a capacitance of the ultrasonic transducer; a capacitance storage to store a capacitance of the ultrasonic transducer at the predetermined temperature; and a determiner to determine an anomaly of the ultrasonic transducer based on the capacitance detected by the capacitance detector, the resonant frequency stored in the storage, and the resonant frequency detected by the frequency detector.

Preferred embodiments of the present invention enable accurate detection of anomalies of the ultrasonic transducer.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic block diagram illustrating a configuration of an ultrasonic apparatus including an ultrasonic transducer.

FIG. 2 is a cross-sectional view of an ultrasonic transducer 100.

FIG. 3 is a block diagram illustrating a configuration of an ultrasonic apparatus according to a first preferred embodiment of the present invention.

FIG. 4 is a diagram for explaining a first example of how a frequency estimator 116 estimates frequency fc.

FIG. 5 is a diagram for explaining a second example of how the frequency estimator 116 estimates frequency fc.

FIG. 6 is a block diagram illustrating a configuration of an ultrasonic apparatus according to a second preferred embodiment of the present invention.

FIG. 7 is a diagram for explaining a first example of how a Q-factor estimator 216 estimates Q factor Qc.

FIG. 8 is a diagram for explaining a second example of how the Q-factor estimator 216 estimates Q factor Qc.

FIG. 9 is a graph showing a relationship between adhesion of water droplets and change in resonant frequency.

FIG. 10 is a graph showing a relationship between adhesion of water droplets and change in Q factor.

FIG. 11 is a graph showing a relationship between adhesion of mud and change in resonant frequency.

FIG. 12 is a graph showing a relationship between adhesion of mud and change in Q factor.

FIG. 13 is a flowchart for explaining a determination process performed in a third preferred embodiment of the present invention.

FIG. 14 is a block diagram illustrating a configuration of an ultrasonic apparatus according to the third preferred embodiment of the present invention.

FIG. 15 is a diagram for explaining an operation of an anomaly determiner 319.

FIG. 16 is a block diagram illustrating a configuration of an ultrasonic apparatus according to a fourth preferred embodiment of the present invention.

FIG. 17 is a diagram for explaining a determination process performed by an anomaly determiner 419.

FIG. 18 is a block diagram illustrating a configuration of an ultrasonic apparatus according to a fifth preferred embodiment of the present invention.

FIG. 19 is a diagram for explaining a first example of how a temperature detector 112 estimates temperature Tc.

FIG. 20 is a diagram for explaining a second example of how the temperature detector 112 estimates temperature Tc.

FIG. 21 is a block diagram illustrating a configuration of an ultrasonic apparatus according to a sixth preferred embodiment of the present invention.

FIG. 22 is a diagram for explaining a first example of estimation performed by a Q-factor estimator 616.

FIG. 23 is a diagram for explaining a second example of estimation performed by the Q-factor estimator 616.

FIG. 24 is a block diagram illustrating a configuration of an ultrasonic apparatus according to a modification of the sixth preferred embodiment of the present invention.

FIG. 25 is a block diagram illustrating a configuration of an ultrasonic apparatus according to a seventh preferred embodiment of the present invention.

FIG. 26 is a diagram for explaining estimation performed by a Q-factor estimator 816.

FIG. 27 is a block diagram illustrating a configuration of an ultrasonic apparatus according to a modification of the seventh preferred embodiment of the present invention.

### DETAILED DESCRIPTION OF THE PREFERRED EMBODIMENTS

Preferred embodiments of the present invention will be described in detail with reference to the drawings. The same or equivalent elements and portions throughout the drawings are denoted by the same reference numerals and their description will not be repeated.

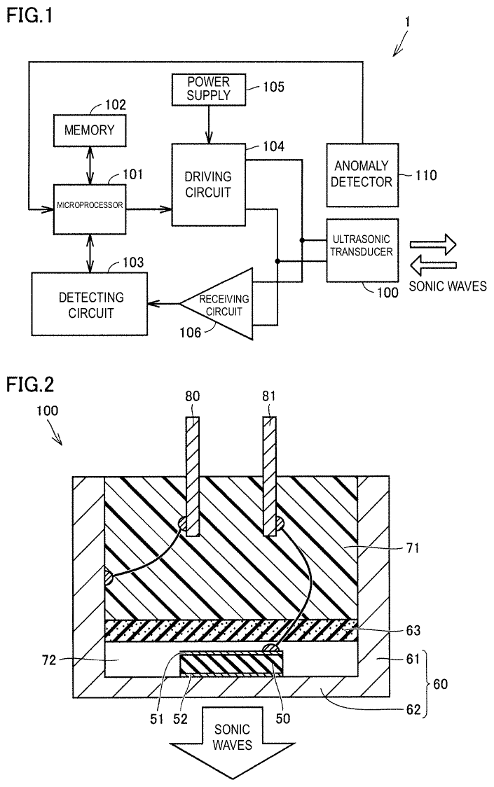

FIG. 1 is a schematic block diagram illustrating a configuration of an ultrasonic apparatus including an ultrasonic transducer. An ultrasonic apparatus 1 includes an ultrasonic transducer 100, a microprocessor 101, a memory 102, a detecting circuit 103, a driving circuit 104, a power supply 105, a receiving circuit 106, and an anomaly detector 110.

The microprocessor 101 reads data stored in the memory 102 and outputs, to the driving circuit 104, a control signal suitable to drive the ultrasonic transducer 100. The power supply 105 outputs, for example, a direct-current voltage of about 12 V to the driving circuit 104. The driving circuit 104 generates an alternating-current voltage from the direct-current voltage based on the control signal output from the microprocessor 101. The alternating-current voltage is boosted, as appropriate, by an amplifying circuit (not shown) and supplied to the ultrasonic transducer 100. The ultrasonic transducer 100 is driven, and ultrasonic waves are transmitted from the ultrasonic transducer 100, for example, into the air.

When the ultrasonic transducer 100 receives reflected waves from a target, a receive signal generated in the ultrasonic transducer 100 is transmitted as a voltage value to the receiving circuit 106, further transmitted through the detecting circuit 103, and input to the microprocessor 101. The microprocessor 101 thus acquires information about the presence and movement of the target. The ultrasonic apparatus 1 may be used, for example, as an ultrasonic sensor mounted on a vehicle.

FIG. 2 is a cross-sectional view of the ultrasonic transducer 100. The configuration of the ultrasonic transducer disclosed in FIG. 2 is merely an example. Even when an ultrasonic transducer having a different configuration is used, the ultrasonic apparatuses of preferred embodiments are able to detect anomalies of the ultrasonic transducer. The ultrasonic transducer 100 illustrated in FIG. 2 includes a piezoelectric element 50, a case 60, a sound absorber 63, and terminals 80 and 81. The case 60 has a cylindrical or substantially cylindrical shape with a bottom. The case 60 is preferably made of, for example, light-weight aluminum with high elasticity. The case 60 is preferably made, for example, by an aluminum forging or cutting process.

The case 60 includes a disk-shaped bottom portion 62 and a cylindrical tubular portion 61 disposed along the periphery of the bottom portion 62. The piezoelectric element 50 is preferably made of, for example, PZT ceramic. The piezoelectric element 50 is disposed on the inner surface of the bottom portion 62 and bonded thereto with an adhesive. While the ultrasonic transducer 100 is being driven, the piezoelectric element 50 vibrates in bending directions together with the bottom portion 62. The inner space of the case 60 is filled with resin 71. The sound absorber 63 is preferably defined by a molded body of sponge material or the like, and is interposed between the resin 71 and a portion 72 to accommodate the piezoelectric element 50. The sound absorber 63 is opposite, and at a distance from, the piezoelectric element 50.

The piezoelectric element 50 includes two electrodes 51 and 52. The terminal 80 is electrically connected to the electrode 52, with a wire and the case 60 interposed therebetween. The terminal 81 is electrically connected to the electrode 51, with a wire interposed therebetween.

The ultrasonic transducer 100 illustrated in FIG. 1 may be a two-terminal transducer, such as that illustrated in FIG. 2, or may be a three-terminal transducer with GND and transmitting and receiving terminals.

### First Preferred Embodiment

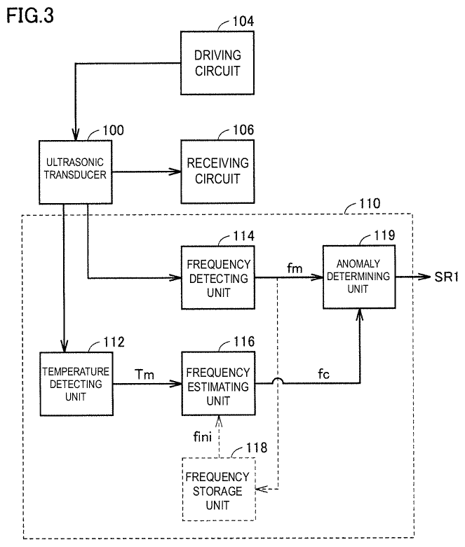

FIG. 3 is a block diagram illustrating a configuration of an ultrasonic apparatus according to a first preferred embodiment of the present invention. The ultrasonic apparatus of the first preferred embodiment includes the ultrasonic transducer 100, the driving circuit 104, the receiving circuit 106, and the anomaly detector 110.

The anomaly detector 110 includes a frequency detector 114, a frequency storage 118, a frequency estimator 116, a temperature detector 112, and an anomaly determiner 119.

The driving circuit 104 outputs a driving signal so as to cause the ultrasonic transducer 100 to transmit sonic waves. The receiving circuit 106 receives sonic waves received by the ultrasonic transducer 100.

The frequency detector 114 detects a resonant frequency fm of the ultrasonic transducer 100. The frequency storage 118 stores the resonant frequency fm of the ultrasonic transducer 100 at a predetermined temperature. For example, the resonant frequency fm detected by the frequency detector 114 when, in the process of producing ultrasonic apparatuses at the factory, the ultrasonic transducer 100 is resonated in an atmosphere of predetermined temperature, is stored as an initial value fini in the frequency storage 118.

The frequency detector 114 and the temperature detector 112 of any known types may be used. For example, the frequency detector 114 may be a circuit that measures a resonant frequency from a reverberation frequency, as described for example in Japanese Unexamined Patent Application Publication No. 2015-10888. The temperature detector 112 may include a thermo-sensitive element, such as a thermistor, or may be configured to receive temperature information from an external temperature sensor mounted, for example, on a vehicle.

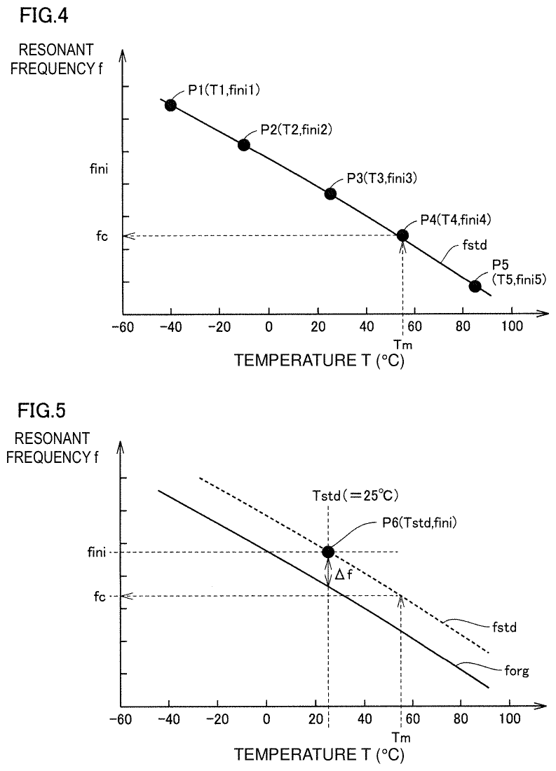

FIG. 4 is a diagram for explaining a first example of how the frequency estimator 116 estimates a frequency fc. Referring to FIG. 3 and FIG. 4, resonant frequencies (fini1, fini2, fini3, fini4, and fini5) are measured at given temperatures (T1, T2, T3, T4, and T5) when the ultrasonic transducer 100 in the factory default state is known to have no anomaly. There may be either one or a plurality of temperature points. The measured values at measurement points P1 to P5 are stored in the frequency storage 118. From the frequencies stored, the frequency estimator 116 determines a temperature-resonant frequency relationship fstd for each individual ultrasonic transducer.

The temperature-resonant frequency relationship may be calculated, for example, by storing table data of temperatures and resonant frequencies, and linearly interpolating the stored data. The relationship may be mathematically expressed, for example, by a linear, quadratic, or polynomial expression, and coefficients in the mathematical expression may be determined from the measurement points P1 to P5.

From fstd provided by such a mathematical expression or table, the frequency estimator 116 determines a value corresponding to a temperature Tm obtained from the temperature detector 112 during use. The frequency estimator 116 thus estimates the estimated resonant frequency fc.

The temperature characteristic data may be measured, as illustrated in FIG. 4, for each individual ultrasonic transducer so that the data is able to be used to determine the estimated resonant frequency fc. It takes time, however, to measure and record the temperature characteristic data for each individual ultrasonic transducer. Therefore, it is more realistic to perform a second example (described below) in which the initial value fini at a standard temperature Tstd is measured and recorded for each individual transducer, and common standard data is used to compensate for a frequency shift Δf associated with a change in temperature characteristic.

FIG. 5 is a diagram for explaining the second example of how the frequency estimator 116 estimates the frequency fc. Referring to FIG. 3 and FIG. 5, the resonant frequency fini of the ultrasonic transducer 100 measured at a predetermined temperature (e.g., Tstd=about 25° C.) (corresponding to P6 in FIG. 5) is stored in the frequency storage 118. An ultrasonic transducer's temperature-resonant frequency characteristic (forg in FIG. 5), used in common by a plurality of ultrasonic apparatuses, is stored in the frequency estimator 116. The temperature-resonant frequency characteristic (forg) may be stored as a function (mathematical expression) of temperature, or may be stored as a data table like a map.

The shift Δf between the resonant frequency fini at the temperature Tstd, corresponding to each individual ultrasonic transducer 100, and the temperature-resonant frequency characteristic (forg), is calculated. The frequency shift Δf is a shift resulting from an individual difference. Then, the temperature-resonant frequency characteristic (forg) is shifted by Δf to determine the temperature-resonant frequency characteristic (fstd). From fstd provided by a mathematical expression or table, the frequency estimator 116 determines a value corresponding to the temperature Tm obtained from the temperature detector 112 during use. The frequency estimator 116 thus estimates the estimated resonant frequency fc.

Although not shown, a difference Δf1 between a resonant frequency corresponding to the predetermined temperature Tstd and a resonant frequency at the temperature Tm in the temperature-resonant frequency characteristic (forg) may be calculated and added to fini to determine fc.

Referring back to FIG. 3, upon receiving the current measured temperature Tm from the temperature detector 112, the frequency estimator 116 outputs the estimated resonant frequency fc. Note that although fini stored in the frequency storage 118 is transmitted to the frequency estimator 116 in FIG. 3, fstd shown in FIG. 4 and FIG. 5 may be computed and stored in the frequency storage 118 in advance and referenced by the frequency estimator 116.

The anomaly determiner 119 determines an anomaly of the ultrasonic transducer 100 based on the temperature Tm detected by the temperature detector 112, the resonant frequency fini stored in the frequency storage 118, and the resonant frequency fm detected by the frequency detector 114. The anomaly determiner 119 then outputs a signal SR1 representing the determination result.

More specifically, the frequency estimator 116 estimates the frequency estimate fc at the temperature Tm based on the temperature Tm and the initial value fini, and the anomaly determiner 119 compares the frequency estimate fc with the resonant frequency fm, which is a measured value, to determine whether the measured value is anomalous. For example, the anomaly determiner 119 determines a positive-side threshold f(+) and a negative-side threshold f(−), with the frequency estimate fc at the center. Then, if f(−)<fm<f(+) is satisfied, the anomaly determiner 119 determines that the measured value is normal, and if not satisfied, the anomaly determiner 119 determines that the measured value is anomalous.

With the configuration described above, the ultrasonic apparatus according to the first preferred embodiment is able to detect anomalies of the ultrasonic transducer more accurately than before.

That is, the method described in Japanese Patent No. 2998232 detects anomalies based on changes in frequency, but the frequency also changes with temperature. For detection of anomalies, such as adhesion of a foreign substance (e.g., water or mud), it is necessary to determine whether the change in frequency is caused by a temperature change or by adhesion. Accordingly, the first preferred embodiment provides the temperature detector 112, in addition to the frequency detector 114, so that a change in frequency at a detected temperature is reflected in a determination threshold. This enables determination as to whether the change in frequency is caused by a temperature change or by an anomaly.

### Second Preferred Embodiment

A resonant frequency is used as a parameter to determine an anomaly in the first preferred embodiment, but a Q factor is used in a second preferred embodiment of the present invention. The Q factor is an index generally used as a value “quality factor (Q)” representing the degree of sharpness, that is, how sharp the resonance peak of the resonant circuit is. The inventors of preferred embodiments of the present application have discovered that an anomaly, such as adhesion of mud, is also able to be detected as a change in Q factor.

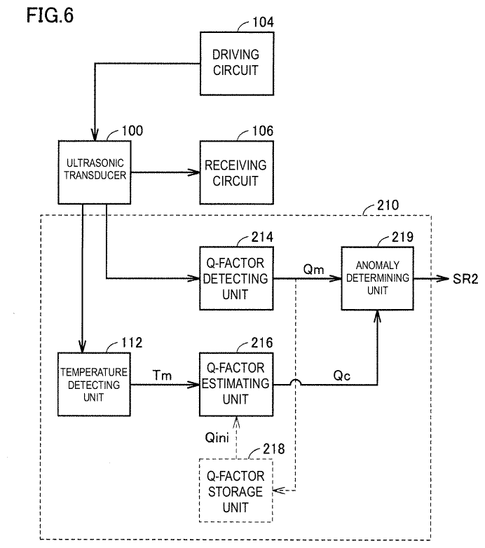

FIG. 6 is a block diagram illustrating a configuration of an ultrasonic apparatus according to the second preferred embodiment. The ultrasonic apparatus according to the second preferred embodiment includes the ultrasonic transducer 100, the driving circuit 104, the receiving circuit 106, and an anomaly detector 210.

The anomaly detector 210 includes a Q-factor detector 214, a Q-factor storage 218, a Q-factor estimator 216, the temperature detector 112, and an anomaly determiner 219.

The description of the driving circuit 104, the receiving circuit 106, and the temperature detector 112, which are the same or substantially the same as those of the first preferred embodiment, will not be repeated here.

The Q-factor detector 214 detects a Q factor Qm of the ultrasonic transducer 100. The Q-factor storage 218 stores the Q factor Qm of the ultrasonic transducer 100 at a predetermined temperature. For example, the Q factor Qm detected by the Q-factor detector 214 when, in the process of producing ultrasonic apparatuses at the factory, the ultrasonic transducer 100 is vibrated in an atmosphere of predetermined temperature, is stored as an initial value Qini in the Q-factor storage 218.

The Q-factor detector 214 of any known type may be used. For example, the Q-factor detector 214 measures the Q factor from the attenuation curve of reverberation frequency as described, for example, in Japanese Unexamined Patent Application Publication No. 2015-10888.

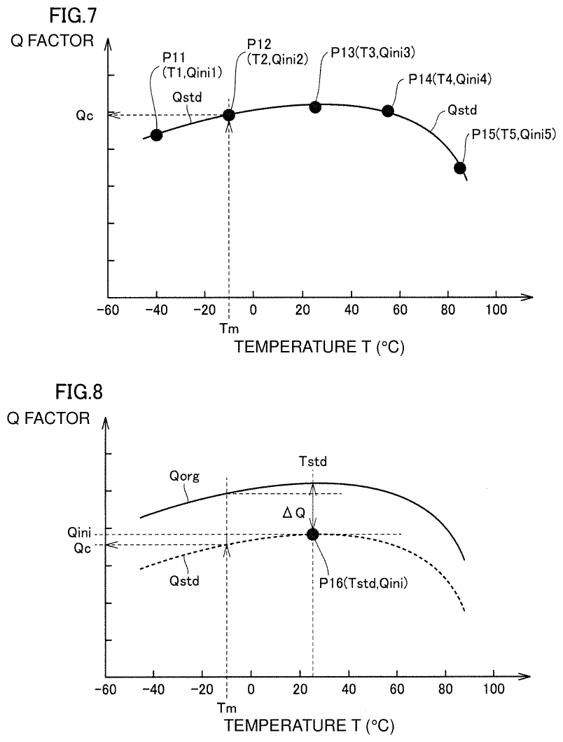

FIG. 7 is a diagram for explaining a first example of how the Q-factor estimator 216 estimates a Q factor Qc. Referring to FIG. 6 and FIG. 7, Q factors (Qini1, Qini2, Qini3, Qini4, and Qini5) are measured at given temperatures (T1, T2, T3, T4, and T5) when the ultrasonic transducer 100 in the factory default state is known to have no anomaly. There may be either one or a plurality of temperature points. The measured values at measurement points P11 to P15 are stored in the Q-factor storage 218. From the Q factors stored, the Q-factor estimator 216 determines a temperature-Q factor relationship Qstd for each individual ultrasonic transducer.

The temperature-Q factor relationship may be calculated, for example, by storing table data of temperatures and Q factors, and linearly interpolating the stored data. The relationship may be mathematically expressed, for example, by a linear, quadratic, or polynomial expression, and coefficients in the mathematical expression may be determined from the measurement points P11 to P15.

From Qstd provided by such a mathematical expression or table, the Q-factor estimator 216 determines a value corresponding to the temperature Tm obtained from the temperature detector 112 during use. The Q-factor estimator 216 thus estimates the estimated Q factor Qc.

The temperature characteristic data may be measured, as illustrated in FIG. 7, for each individual ultrasonic transducer so that the data may be used to determine the estimated Q factor Qc. It takes time, however, to measure and record the temperature characteristic data for each individual ultrasonic transducer. Therefore, it is more realistic to perform a second example (described below) in which the initial value Qini at the standard temperature Tstd is measured and recorded for each individual transducer, and common data is used to compensate for a Q factor shift ΔQ associated with a change in temperature characteristic.

FIG. 8 is a diagram for explaining the second example of how the Q-factor estimator 216 estimates the Q factor Qc. Referring to FIG. 6 and FIG. 8, the Q factor Qini of the ultrasonic transducer 100 measured at a predetermined temperature (e.g., Tstd=about 25° C.) (corresponding to P16 in FIG. 8) is stored in the Q-factor storage 218. An ultrasonic transducer's temperature-Q factor characteristic (Qorg), used in common by a plurality of ultrasonic apparatuses, is stored in the Q-factor estimator 216. The temperature-Q factor characteristic (Qorg) may be stored as a function (mathematical expression) of temperature, or may be stored as a data table like a map.

The Q factor shift ΔQ between the Q factor Qini at the temperature Tstd, corresponding to each individual ultrasonic transducer 100, and the temperature-Q factor characteristic (Qorg), is calculated. The Q factor shift ΔQ is a shift resulting from an individual difference. Then, the temperature-Q factor characteristic (Qorg) is shifted by ΔQ to determine the temperature-Q factor characteristic (Qstd). From Qstd provided by a mathematical expression or table, the Q-factor estimator 216 determines a value corresponding to the temperature Tm obtained from the temperature detector 112 during use. The Q-factor estimator 216 thus estimates the estimated Q factor Qc.

Although not shown, a difference ΔQ1 between a Q factor corresponding to the predetermined temperature Tstd and a Q factor at the temperature Tm in the temperature-Q factor characteristic (Qorg) may be calculated and added to Qini to determine Qc.

Upon receiving the current measured temperature Tm from the temperature detector 112, the Q-factor estimator 216 outputs the estimated Q factor Qc. Note that although Qini stored in the Q-factor storage 218 is transmitted to the Q-factor estimator 216 in FIG. 6, Qstd shown in FIG. 7 and FIG. 8 may be computed and stored in the Q-factor storage 218 in advance and referenced by the Q-factor estimator 216.

The anomaly determiner 219 determines an anomaly of the ultrasonic transducer 100 based on the temperature Tm detected by the temperature detector 112, the Q factor Qini stored in the Q-factor storage 218, and the Q factor Qm detected by the Q-factor detector 214. The anomaly determiner 219 then outputs a signal SR2 representing the determination result.

More specifically, the Q-factor estimator 216 estimates the Q factor estimate Qc at the temperature Tm based on the temperature Tm and the initial value Qini, and the anomaly determiner 219 compares the Q factor estimate QC with Qm, which is a measured value, to determine whether the measured value is anomalous. For example, the anomaly determiner 219 determines a positive-side threshold Q(+) and a negative-side threshold Q(−), with the Q factor estimate Qc at the center. Then, if Q(−)<Qm<Q(+) is satisfied, the anomaly determiner 219 determines that the measured value is normal, and if not satisfied, the anomaly determiner 219 determines that the measured value is anomalous.

With the configuration described above, the ultrasonic apparatus according to the second preferred embodiment performs temperature compensation of the Q factor, and thus is able to accurately detect anomalies of the ultrasonic transducer. Anomaly detection which involves using Q factors alone has not been conventionally performed. It is therefore expected that previously undetectable anomalies will be detected.

### Third Preferred Embodiment

In the second preferred embodiment, a Q factor (sharpness of resonance) is used to determine an anomaly. In a third preferred embodiment of the present invention, anomalies are classified by observing changes in both resonant frequency and Q factor at the same time.

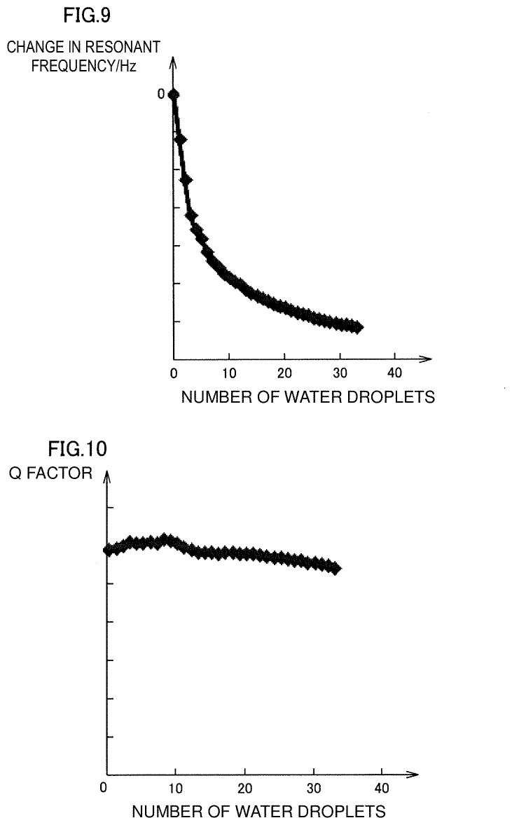

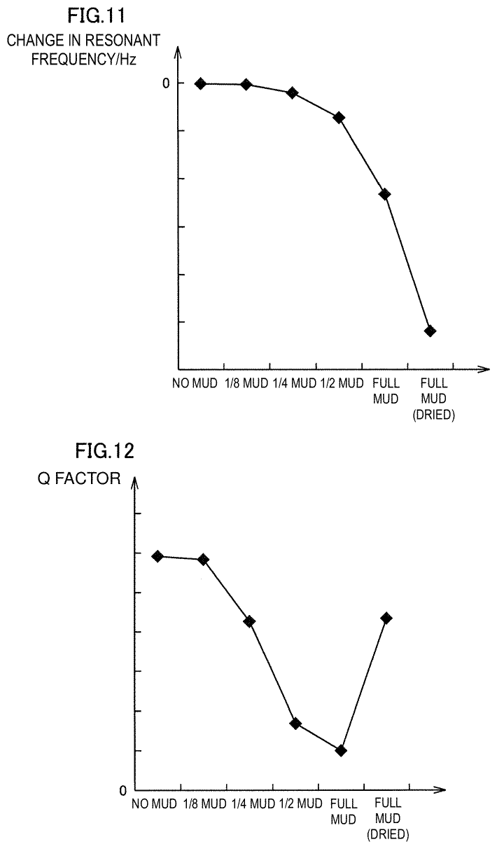

FIG. 9 is a graph showing a relationship between adhesion of water droplets and change in resonant frequency. FIG. 10 is a graph showing a relationship between adhesion of water droplets and change in Q factor. FIG. 11 is a graph showing a relationship between adhesion of mud and change in resonant frequency. FIG. 12 is a graph showing a relationship between adhesion of mud and change in Q factor.

As can be seen in FIG. 9 and FIG. 10, adhesion of water droplets to the vibrating surface of the ultrasonic transducer 100 changes the resonant frequency, but causes little change in Q factor. On the other hand, as can be seen in FIG. 11 and FIG. 12, adhesion of mud changes (or lowers) both the resonant frequency and the Q factor.

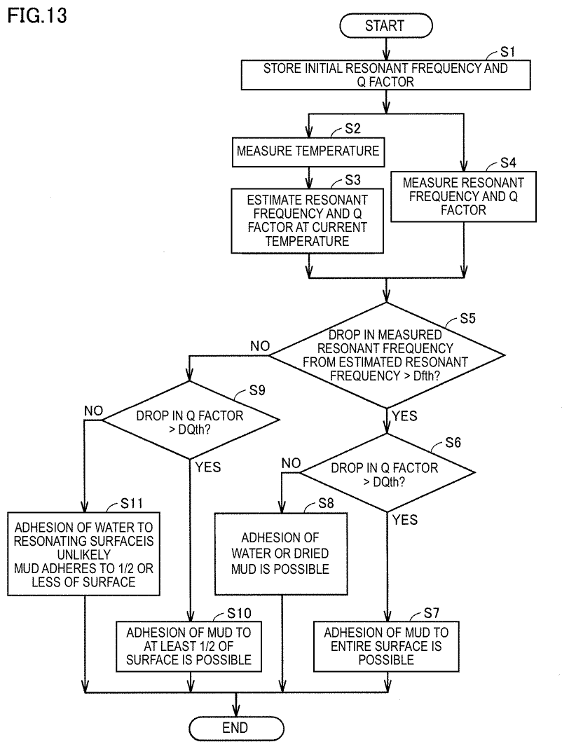

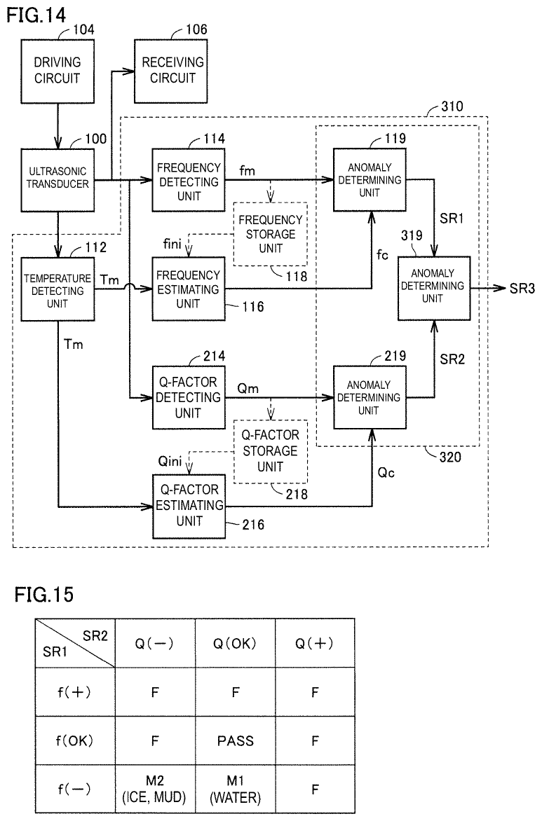

FIG. 13 is a flowchart for explaining a determination process performed in the third preferred embodiment. Referring to FIG. 13, in step S1, an anomaly detector according to the third preferred embodiment stores an initial resonant frequency and an initial Q factor in storages. Next, the temperature Tm is measured in step S2, and the resonant frequency fc and the Q factor Qc at the current temperature Tm are estimated in step S3.

In parallel with the operations in steps S2 and S3, the current resonant frequency fm and the current Q factor Qm are measured in step S4.

After completion of the operations in step S3 and step S4, a determination is made as to whether a drop Df in the measured resonant frequency fm relative to the estimated resonant frequency fc is larger than a determination threshold Dfth in step S5. If Df>Dfth holds (YES in S5), the process proceeds from step S5 to step S6, where a determination is made as to whether a drop DQ in Q factor is larger than a determination threshold DQth.

If DQ>DQth is satisfied in step S6 (YES in S6), the process proceeds to step S7, where it is determined that adhesion of mud to the entire or substantially the entire resonating surface (or bottom portion 62 in FIG. 2) of the ultrasonic transducer 100 is possible. If DC>DQth is not satisfied (NO in S6), the process proceeds to step S8, where it is determined that adhesion of water to the resonating surface or adhesion of dried mud is possible.

If Df>Dfth is not satisfied in step S5 (NO in S5), the process proceeds from step S5 to step S9, where a determination is made as to whether the drop DQ in Q factor is larger than the determination threshold DQth.

If DQ>DQth is maintained in step S9 (YES in S9), the process proceeds to step S10, where it is determined that adhesion of mud to at least ½ of the resonating surface of the ultrasonic transducer 100 is possible. On the other hand, if DQ>DQth 9 is not satisfied (NO in S9), the process proceeds to step S11, where it is determined that adhesion of water to the resonating surface is unlikely, and that mud adheres to ½ or less of the resonating surface.

FIG. 14 is a block diagram illustrating a configuration of an ultrasonic apparatus according to the third preferred embodiment. The ultrasonic apparatus according to the third preferred embodiment includes the ultrasonic transducer 100, the driving circuit 104, the receiving circuit 106, and an anomaly detector 310.

The anomaly detector 310 includes the temperature detector 112, the frequency detector 114, the frequency storage 118, the frequency estimator 116, and the anomaly determiner 119. The description of the temperature detector 112, the frequency detector 114, the frequency storage 118, the frequency estimator 116, and the anomaly determiner 119, which are the same or substantially the same as those described in the first preferred embodiment (FIG. 3), will not be repeated here.

The anomaly detector 310 further includes the Q-factor detector 214, the Q-factor storage 218, the Q-factor estimator 216, and the anomaly determiner 219. The description of the Q-factor detector 214, the Q-factor storage 218, the Q-factor estimator 216, and the anomaly determiner 219, which are the same or substantially the same as those described in the second preferred embodiment (FIG. 6), will not be repeated here.

The anomaly detector 310 further includes an anomaly determiner 319. The anomaly determiner 319 defines a determining section 320 together with the anomaly determiners 119 and 219. The determining section 320 determines an anomaly of the ultrasonic transducer 100 based on the temperature Tm detected by the temperature detector 112, the resonant frequency fini stored in the frequency storage 118, the resonant frequency fm detected by the frequency detector 114, the Q factor Qini stored in the Q-factor storage 218, and the Q factor Qm detected by the Q-factor detector 214.

From the results of determinations made by the anomaly determiners 119 and 219, the anomaly determiner 319 comprehensively determines the anomaly state. The anomaly determiner 319 is capable of determining whether the anomaly state is either adhesion of water, or freezing or adhesion of mud.

FIG. 15 is a diagram for explaining an operation of the anomaly determiner 319. Referring to FIG. 15, “f(OK)” means that the signal SR1 indicates that the resonant frequency fm is between the positive-side threshold f(+) and the negative-side threshold f(−) determined by the estimated resonant frequency fc, and “Q(OK)” means that the signal SR2 indicates that the Q factor Qm is between the positive-side threshold Q(+) and the negative-side threshold Q(−) determined by the estimated Q factor Qc.

Also in FIG. 15, “f(+)” means that fm is higher than the positive-side threshold f(+), and “f(−)” means that fm is lower than the negative-side threshold f(−).

Also in FIG. 15, “Q(+)” means that Qm is larger than the positive-side threshold Q(+), and “Q(−)” means that Qm is smaller than the negative-side threshold Q(−).

If the signal SR1 corresponds to “f(OK)” and the signal SR2 corresponds to “Q(OK)”, the anomaly determiner 319 outputs “PASS” as a determination result SR3. The output “PASS” indicates that the ultrasonic transducer 100 is normal.

If the signal SR1 corresponds to “f(−)” lower than the negative-side threshold and the signal SR2 corresponds to “Q(−)” lower than the negative-side threshold, the anomaly determiner 319 outputs “M2” as the determination result SR3. The output “M2” indicates possible adhesion of ice or mud to the ultrasonic transducer 100.

If the signal SR1 corresponds to “f(−)” lower than the negative-side threshold and the signal SR2 corresponds to “Q(OK)”, the anomaly determiner 319 outputs “M1” as the determination result SR3. The output “M1” indicates possible adhesion of water to the ultrasonic transducer 100.

Otherwise, the letter “F” is shown in FIG. 15 and this indicates a possible failure of the ultrasonic transducer 100.

As described above, the ultrasonic apparatus of the third preferred embodiment is capable of making a detail estimation of the anomaly state of the ultrasonic transducer 100. That is, the anomaly is able to be identified either as adhesion of water or as adhesion or freezing of mud, depending on the combination of frequency and Q factor. This is applicable, for example, to classification of higher-precision control and repair operations.

### Fourth Preferred Embodiment

A fourth preferred embodiment of the present invention is similar to the third preferred embodiment, but differs therefrom in a determination performed by the anomaly determiner.

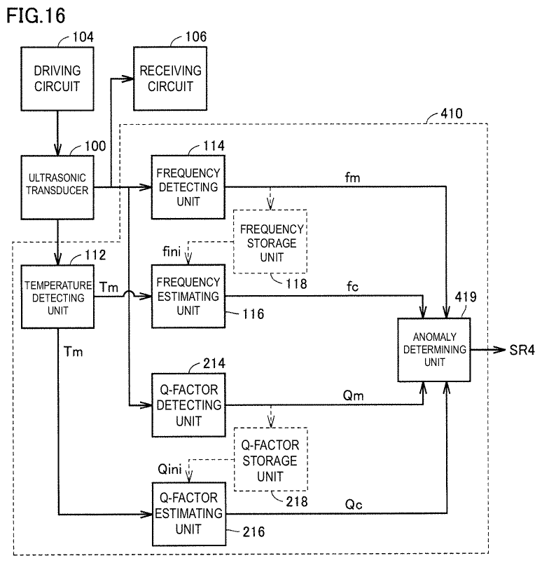

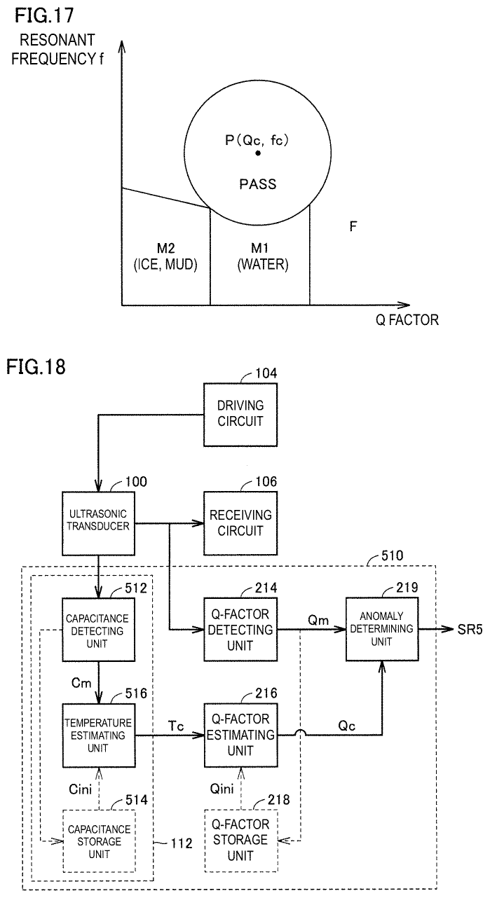

FIG. 16 is a block diagram illustrating a configuration of an ultrasonic apparatus according to the fourth preferred embodiment. The ultrasonic apparatus of the fourth preferred embodiment includes the ultrasonic transducer 100, the driving circuit 104, the receiving circuit 106, and an anomaly detector 410.

The anomaly detector 410 includes the temperature detector 112, the frequency detector 114, the frequency storage 118, the frequency estimator 116, the Q-factor detector 214, the Q-factor storage 218, the Q-factor estimator 216, and an anomaly determiner 419.

The temperature detector 112, the frequency detector 114, the frequency storage 118, and the frequency estimator 116 are the same or substantially the same as those described in the first preferred embodiment (FIG. 3). The Q-factor detector 214, the Q-factor storage 218, and the Q-factor estimator 216 are the same or substantially the same as those described in the second preferred embodiment (FIG. 6). Therefore, the description of these components will not be repeated here.

The anomaly determiner 419 determines an anomaly of the ultrasonic transducer 100 based on the resonant frequency fc estimated by the frequency estimator 116, the resonant frequency fm detected by the frequency detector 114, the Q factor Qc estimated by the Q-factor estimator 216, and the Q factor Qm detected by the Q-factor detector 214.

FIG. 17 is a diagram for explaining a determination process performed by the anomaly determiner 419. The anomaly determiner 419 comprehensively determines an anomaly from the following four values: the measured and estimated resonant frequencies, and the measured and estimated Q factors. Referring to FIG. 17, the anomaly determiner 419 determines whether an anomaly occurs based on whether coordinates Pm(Qm, fm) are in a PASS region centered at coordinates P(Qc, fc) in the Q-f plane. Thus, as illustrated in FIG. 17, detailed setting of regions corresponding to the determination results PASS, M1, M2, and F may be made in accordance with, for example, actual experimental results.

The fourth preferred embodiment is configured similarly to the third preferred embodiment, but differs therefrom in that, instead of combining the results individually determined for the resonant frequency and the Q factor, a determination may be made at a time based on the combination of the resonant frequency and the Q factor which are in a combined state from the beginning. Thus, with the configuration of the fourth preferred embodiment, a high-precision determination is able to be made with efficiency.

### Fifth Preferred Embodiment

In the first to fourth preferred embodiments, a temperature sensor of any of various known types is used as the temperature detector 112. In a fifth preferred embodiment of the present invention, however, the temperature detector 112 performs temperature estimation by detecting a change in the capacitance of the piezoelectric element of the ultrasonic transducer 100. Although the temperature detector 112 is applicable to any of the first to fourth preferred embodiments, the temperature detector 112 used in the second preferred embodiment will be described as an example.

FIG. 18 is a block diagram illustrating a configuration of an ultrasonic apparatus according to the fifth preferred embodiment. Referring to FIG. 18, the ultrasonic apparatus of the fifth preferred embodiment includes the ultrasonic transducer 100, the driving circuit 104, the receiving circuit 106, and an anomaly detector 510.

The anomaly detector 510 includes the Q-factor detector 214, the Q-factor storage 218, the Q-factor estimator 216, the temperature detector 112, and the anomaly determiner 219.

The description of the driving circuit 104, the receiving circuit 106, the Q-factor detector 214, the Q-factor storage 218, the Q-factor estimator 216, and the anomaly determiner 219, which are the same or substantially the same as those described in the first and second preferred embodiments, will not be repeated here.

The temperature detector 112 includes a capacitance detector 512, a capacitance storage 514, and a temperature estimator 516.

The capacitance detector 512 connects a capacitor having a predetermined capacitance value to the capacitor of the piezoelectric element of the ultrasonic transducer 100 such that they are connected in series, and supplies an alternating-current voltage waveform. A voltage at the connection node of the two capacitors connected in series is a voltage obtained by dividing the alternating-current voltage by the capacitance ratio, and thus the capacitance value of the piezoelectric element is able to be detected.

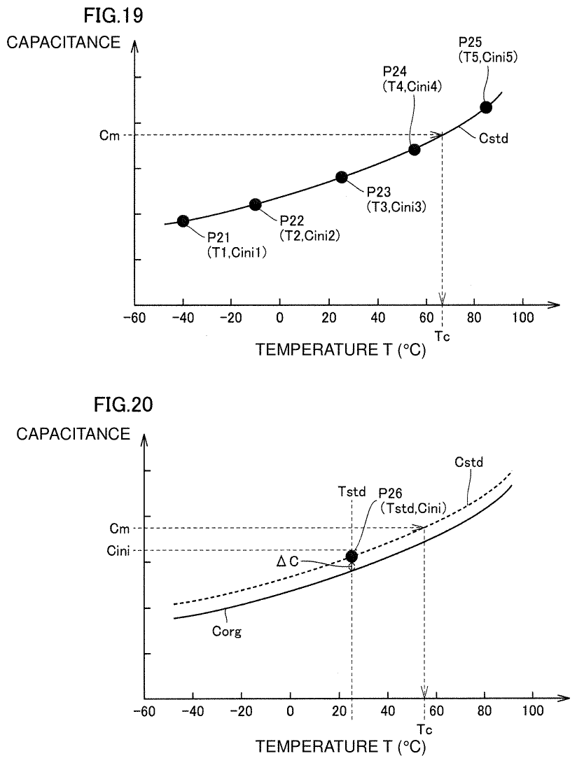

FIG. 19 is a diagram for explaining a first example of how the temperature detector 112 estimates a temperature Tc. Referring to FIG. 18 and FIG. 19, capacitance values (Cini1, Cini2, Cini3, Cini4, and Cini5) are measured at given temperatures (T1, T2, T3, T4, and T5) when the ultrasonic transducer 100 in the factory default state is known to have no anomaly. There may be either one or a plurality of temperature points. The measured values at measurement points P21 to P25 are stored in the capacitance storage 514. From the capacitance values stored, the temperature estimator 516 determines a temperature-capacitance value relationship for each individual ultrasonic transducer.

The temperature-capacitance value relationship may be calculated, for example, by storing table data of temperatures and capacitance values, and linearly interpolating the stored data. The relationship may be mathematically expressed, for example, by a linear, quadratic, or polynomial expression, and coefficients in the mathematical expression may be determined from the measurement points P21 to P25.

From a temperature-capacitance value characteristic Cstd provided by such a mathematical expression or table, the temperature estimator 516 determines a temperature corresponding to a capacitance value Cm obtained from the capacitance detector 512 during use. The temperature estimator 516 thus estimates the estimated temperature Tc.

The temperature-capacitance characteristic data may be measured, as illustrated in FIG. 19, for each individual ultrasonic transducer so that the data may be used to determine the estimated temperature Tc. It takes time, however, to measure and record the temperature-capacitance characteristic data for each individual ultrasonic transducer. Therefore, it is more realistic to perform a second example (described below) in which the initial value Cini at the standard temperature Tstd is measured and recorded for each individual transducer, and common data is used to compensate for a capacitance shift ΔC associated with a change in temperature characteristic.

FIG. 20 is a diagram for explaining the second example of how the temperature detector 112 estimates the temperature Tc. Referring to FIG. 18 and FIG. 20, the capacitance value Cini of the ultrasonic transducer 100 measured at a predetermined temperature (e.g., Tstd=about 25° C.) (corresponding to P26 in FIG. 20) is stored in the capacitance storage 514. An ultrasonic transducer's temperature-capacitance characteristic (Corg), used in common by a plurality of ultrasonic apparatuses, is stored in the temperature estimator 516. The temperature-capacitance characteristic (Corg) may be stored as a function (mathematical expression) of temperature, or may be stored as a data table like a map.

The capacitance value shift ΔC between the capacitance value Cini at the temperature Tstd, corresponding to each individual ultrasonic transducer 100, and the temperature-capacitance characteristic (Corg), is calculated. The capacitance value shift ΔC is a shift resulting from an individual difference. Then, the temperature-capacitance characteristic (Corg) is shifted by ΔC to determine the temperature-capacitance characteristic (Cstd). From Cstd provided by a mathematical expression or table, the temperature estimator 516 determines a temperature corresponding to the capacitance value Cm obtained from the capacitance detector 512 during use. The temperature estimator 516 thus estimates the estimated temperature Tc.

Although not shown, the temperature estimator 516 may calculate a difference ΔC1 between the measured capacitance value Cm and the capacitance value Cini read from the capacitance storage 514 and output, as the estimated temperature Tc, a temperature at which Corg is changed by ΔC1 from that at Tstd.

Upon receiving the estimated temperature Tc from the temperature detector 112, the Q-factor estimator 216 outputs the estimated Q factor Qc. The anomaly determiner 219 performs an operation similar to that described in the second preferred embodiment and outputs a signal SR5 representing the determination result.

The ultrasonic apparatus according to the fifth preferred embodiment detects a temperature based on a detected change in the capacitance of the piezoelectric element originally included in the ultrasonic transducer 100, and thus does not require, for example, an additional temperature sensor.

The fifth preferred embodiment, which requires no additional sensor, is able to achieve the functions of the first to fourth preferred embodiments at low cost.

### Sixth Preferred Embodiment

In the first to fifth preferred embodiments, for example, the Q factor estimate Qc is determined through the use of the temperature Tm or Tc. In a sixth preferred embodiment of the present invention, the resonant frequency fc or the Q factor estimate Qc is estimated directly from the measured capacitance value Cm of the ultrasonic transducer 100.

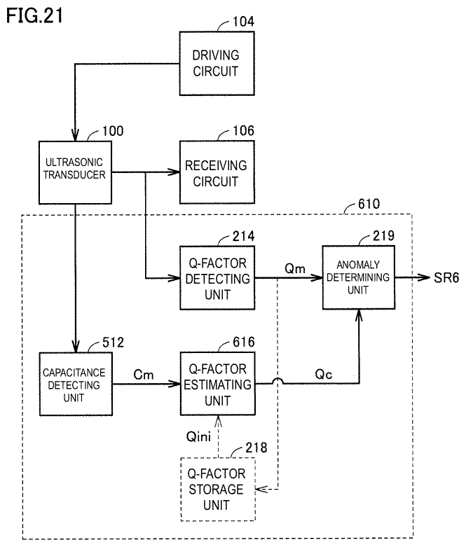

FIG. 21 is a block diagram illustrating a configuration of an ultrasonic apparatus according to the sixth preferred embodiment. Referring to FIG. 21, the ultrasonic apparatus of the sixth preferred embodiment includes the ultrasonic transducer 100, the driving circuit 104, the receiving circuit 106, and an anomaly detector 610.

The anomaly detector 610 includes the Q-factor detector 214, the Q-factor storage 218, the capacitance detector 512, a Q-factor estimator 616, and the anomaly determiner 219.

The description of the driving circuit 104, the receiving circuit 106, the Q-factor detector 214, the Q-factor storage 218, the capacitance detector 512, and the anomaly determiner 219, which are the same or substantially the same as those described in the first, second, and fifth preferred embodiments, will not be repeated here.

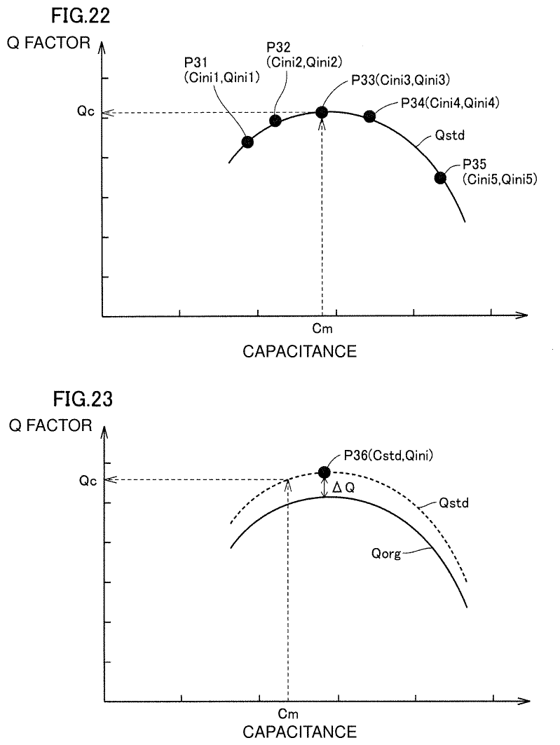

FIG. 22 is a diagram for explaining a first example of estimation performed by the Q-factor estimator 616. Referring to FIG. 21 and FIG. 22, Q factors (Qini1, Qini2, Qini3, Qini4, and Qini5) are measured at capacitance values (Cini1, Cini2, Cini3, Cini4, and Cini5) corresponding to given temperatures (T1, T2, T3, T4, and T5) when the ultrasonic transducer 100 in the factory default state is known to have no anomaly. There may be either one or a plurality of temperature points. The measured values at measurement points P31 to P35 are stored in the Q-factor storage 218. From the Q factors stored, the Q-factor estimator 616 determines a capacitance value-Q factor relationship Qstd for each individual ultrasonic transducer.

The capacitance value-Q factor relationship may be calculated, for example, by storing table data of capacitance values and Q factors, and linearly interpolating the stored data. The relationship may be mathematically expressed, for example, by a linear, quadratic, or polynomial expression, and coefficients in the mathematical expression may be determined from the measurement points P31 to P35.

From Qstd provided by such a mathematical expression or table, the Q-factor estimator 616 determines a value corresponding to the capacitance value Cm obtained from the capacitance detector 512 during use. The Q-factor estimator 616 thus estimates the estimated Q factor Qc.

The capacitance value-Q factor characteristic data may be measured, as illustrated in FIG. 22, for each individual ultrasonic transducer so that the data may be used to determine the estimated Q factor Qc. It takes time, however, to measure and record the capacitance value-Q factor characteristic data for each individual ultrasonic transducer. Therefore, it is more realistic to perform a second example (described below) in which the initial value Qini at the capacitance value Cstd corresponding to the standard temperature Tstd is measured and recorded for each individual transducer, and common data is used to compensate for a Q factor shift ΔQ associated with a change in capacitance characteristic.

FIG. 23 is a diagram for explaining a second example of estimation performed by the Q-factor estimator 616. Referring to FIG. 21 and FIG. 23, the capacitance value Cstd and the Q factor Qini of the ultrasonic transducer 100 measured at a predetermined temperature (e.g., Tstd=about 25° C.) (corresponding to P36 in FIG. 23) are stored in the Q-factor storage 218. An ultrasonic transducer's capacitance value-Q factor characteristic (Qorg), used in common by a plurality of ultrasonic apparatuses, is stored in the Q-factor estimator 616. The capacitance value-Q factor characteristic (Qorg) may be stored as a function (mathematical expression) of the capacitance value, or may be stored as a data table like a map.

The Q factor shift ΔQ between the Q factor Qini at the capacitance Cstd, corresponding to each individual ultrasonic transducer 100, and the capacitance value-Q factor characteristic (Qorg), is calculated. The Q factor shift ΔQ is a shift resulting from an individual difference. Then, the capacitance value-Q factor characteristic (Qorg) is shifted by ΔQ to determine the capacitance value-Q factor characteristic (Qstd). From Qstd provided by a mathematical expression or table, the Q-factor estimator 616 determines a value corresponding to the capacitance value Cm obtained from the capacitance detector 512 during use. The Q-factor estimator 616 thus estimates the estimated Q factor Qc.

Although not shown, a difference ΔQ1 between a Q factor corresponding to the predetermined capacitance value Cstd and a Q factor at the capacitance value Cm in the capacitance value-Q factor characteristic (Qorg) is able to be calculated and added to Qini to determine Qc.

Based on the temperature Tm detected by the temperature detector 112, the Q factor Qini stored in the Q-factor storage 218, and the Q factor Qm detected by the Q-factor detector 214, the anomaly determiner 219 determines an anomaly of the ultrasonic transducer 100 and outputs a signal SR6 representing the determination result.

In the sixth preferred embodiment, the temperature detector 112 of the first to fifth preferred embodiments is replaced by the capacitance detector 512. The frequency estimator and the Q-factor estimator 616 estimate the Q factor directly from the measured capacitance Cm, not from the temperature.

With this configuration, the functions are able to be achieved at low cost. That is, since the same results as those in the fifth preferred embodiment are obtained without the temperature detector, the same functions are able to be achieved at lower cost.

Although the Q factor estimate Qc has been described as an example in the sixth preferred embodiment, application to the resonant frequency fc is also possible by combining with the first preferred embodiment.

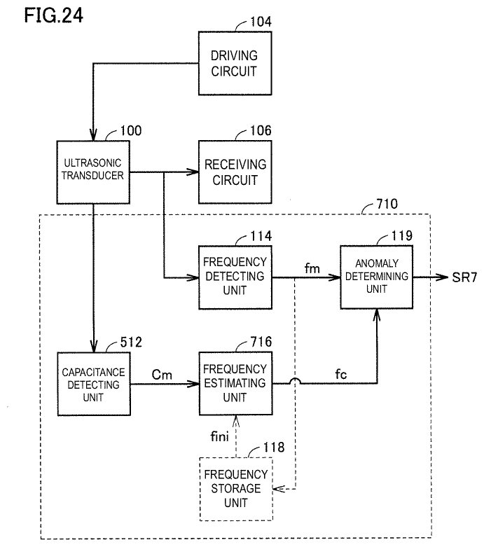

FIG. 24 is a block diagram illustrating a configuration of an ultrasonic apparatus according to a modification of the sixth preferred embodiment. The ultrasonic apparatus according to the present modification of the sixth preferred embodiment includes the ultrasonic transducer 100, the driving circuit 104, the receiving circuit 106, and an anomaly detector 710.

The anomaly detector 710 includes the frequency detector 114, the frequency storage 118, a frequency estimator 716, the capacitance detector 512, and the anomaly determiner 119.

The description of the driving circuit 104, the receiving circuit 106, the frequency detector 114, and the frequency storage 118, which are the same or substantially the same as those illustrated in FIG. 3, will not be repeated here. The description of the capacitance detector 512, which is the same or substantially the same as that illustrated in FIG. 21, will not be repeated here.

The frequency estimator 716 shifts the capacitance-resonant frequency characteristic by taking fini into account to determine the frequency estimate fc. Thus, in the case with the resonant frequency, advantageous effects similar to those achieved in the sixth preferred embodiment are achieved.

### Seventh Preferred Embodiment

In the sixth preferred embodiment, the Q factor estimate Qc varying with changes in ambient environment, such as temperature, is determined directly through the use of map data or a relational expression representing a relationship between capacitance and Q factor. However, there are manufacturing variations among ultrasonic transducers 100. Applying common map data to different ultrasonic transducers 100 may lead to larger errors. A seventh preferred embodiment of the present invention is characterized in that a capacitance change rate is determined so as to reduce errors caused by applying such a common map data or relational expression. Determining a capacitance change rate is applicable to any of the first to fourth preferred embodiments.

For example, as for the capacitance of the piezoelectric element, even when there are manufacturing variations in capacitance value, the change rate (%) of capacitance value associated with changes in temperature does not significantly vary from one element to another. Therefore, if the relationship between capacitance change rates and Q factors is expressed as a map or a relational expression, the resulting data is able to be used as common data during manufacture.

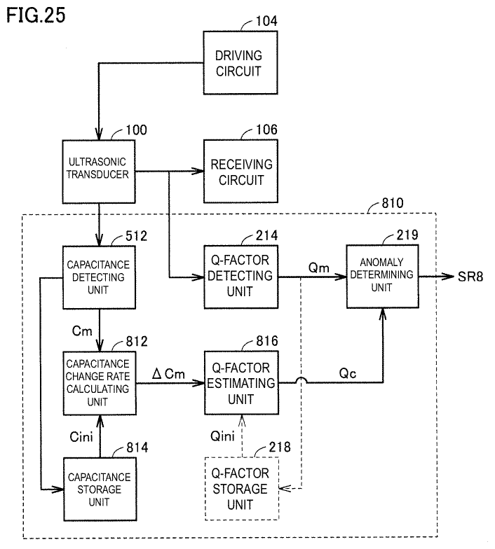

FIG. 25 is a block diagram illustrating a configuration of an ultrasonic apparatus according to the seventh preferred embodiment. Referring to FIG. 25, the ultrasonic apparatus of the seventh preferred embodiment includes the ultrasonic transducer 100, the driving circuit 104, the receiving circuit 106, and an anomaly detector 810.

The anomaly detector 810 includes the Q-factor detector 214, the Q-factor storage 218, the capacitance detector 512, a capacitance storage 814, a capacitance change rate calculator 812, a Q-factor estimator 816, and the anomaly determiner 219.

The description of the driving circuit 104, the receiving circuit 106, the Q-factor detector 214, the Q-factor storage 218, the capacitance detector 512, and the anomaly determiner 219, which are the same or substantially the same as those described in the first, second, and fifth preferred embodiments, will not be repeated here.

The capacitance change rate calculator 812 outputs, as a capacitance change rate ΔCm (%), the rate of change of the capacitance value Cm detected by the capacitance detector 512 with respect to the capacitance value Cini. The Q-factor estimator 816 stores a relationship between capacitance change rates, ΔCini1, ΔCini2, ΔCini3, ΔCini4, and ΔCini5, of the ultrasonic transducer 100 and Q factors at given temperatures (T1, T2, T3, T4, and T5) (capacitance change rate-Q factor characteristic). This relationship is a value that is applicable in common to individual elements.

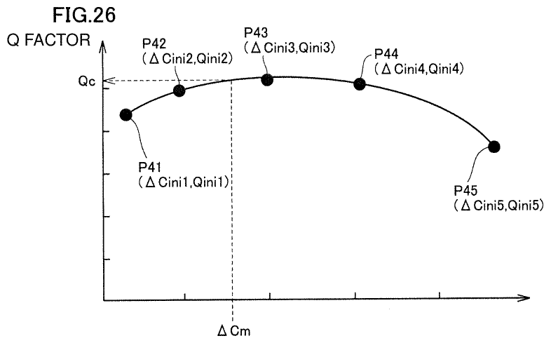

FIG. 26 is a diagram for explaining estimation performed by the Q-factor estimator 816. The Q-factor estimator 816 calculates the capacitance change rate-Q factor characteristic by linear interpolation between measurement points P41 to P45. The relationship may be mathematically expressed, for example, by a polynomial expression, and coefficients in the mathematical expression may be determined from the measurement points P41 to P45. The Q-factor estimator 816 determines a Q factor corresponding to the capacitance change rate ΔCm from the capacitance change rate-Q factor characteristic, and outputs the estimate Qc.

With the configuration of the seventh preferred embodiment, even when there are individual variations in capacitance, errors in estimates caused by the use of a common map or mathematical expression are able to be reduced by input of the capacitance change rate to the Q-factor estimator.

Although the Q factor estimate Qc has been described as an example in the seventh preferred embodiment, application to the resonant frequency fc is also possible by combining with the first preferred embodiment.

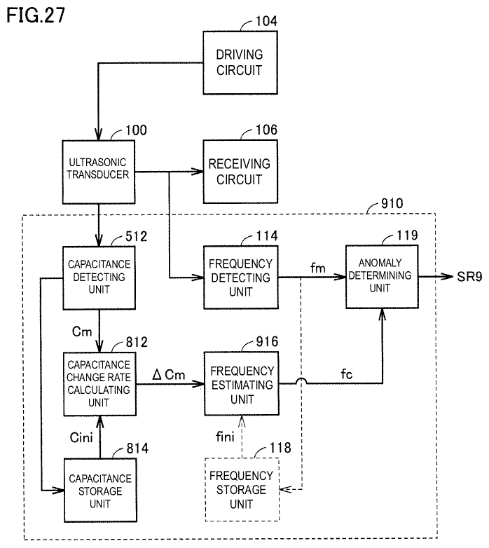

FIG. 27 is a block diagram illustrating a configuration of an ultrasonic apparatus according to a modification of the seventh preferred embodiment. The ultrasonic apparatus according to the present modification of the seventh preferred embodiment includes the ultrasonic transducer 100, the driving circuit 104, the receiving circuit 106, and an anomaly detector 910.

The anomaly detector 910 includes the frequency detector 114, the frequency storage 118, a frequency estimator 916, the capacitance detector 512, the capacitance storage 814, the capacitance change rate calculator 812, and the anomaly determiner 119.

The description of the driving circuit 104, the receiving circuit 106, the frequency detector 114, and the frequency storage 118, which are the same or substantially the same as those illustrated in FIG. 3, will not be repeated here. The description of the capacitance detector 512, the capacitance change rate calculator 812, and the capacitance storage 814, which are the same or substantially the same as those illustrated in FIG. 25, will not be repeated here.

The frequency estimator 916 determines a resonant frequency corresponding to the capacitance change rate ΔCm from the capacitance change rate-resonant frequency characteristic, and outputs the estimated resonant frequency fc.

Advantageous effects similar to those of the seventh preferred embodiment are thus able to be achieved in the case with a resonant frequency.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An ultrasonic apparatus comprising:
an ultrasonic transducer;
a driving circuit to cause the ultrasonic transducer to transmit sonic waves;
a receiving circuit to receive sonic waves received by the ultrasonic transducer;
a frequency detector to detect a resonant frequency of the ultrasonic transducer;
a storage to store a resonant frequency of the ultrasonic transducer at a predetermined temperature;
a temperature detector; and
a determiner to determine an anomaly of the ultrasonic transducer based on a temperature detected by the temperature detector, the resonant frequency stored in the storage, and the resonant frequency detected by the frequency detector.

2. The ultrasonic apparatus according to claim 1, wherein
the temperature detector includes:
a capacitance detector to detect a capacitance of the ultrasonic transducer;
a capacitance storage to store a capacitance of the ultrasonic transducer at the predetermined temperature; and
a temperature estimator to estimate a temperature based on the capacitance detected by the capacitance detector and the capacitance stored by the capacitance storage.

3. The ultrasonic apparatus according to claim 1, wherein the temperature detector includes a thermistor.

4. The ultrasonic apparatus according to claim 1, wherein
the ultrasonic transducer includes a piezoelectric element,
a case, a sound absorber, and terminals; and
the case has a cylindrical or substantially cylindrical shape with a bottom.

5. An ultrasonic apparatus comprising:
an ultrasonic transducer;
a driving circuit to cause the ultrasonic transducer to transmit sonic waves;
a receiving circuit to receive sonic waves received by the ultrasonic transducer;
a Q-factor detector to detect a Q factor of the ultrasonic transducer;
a storage to store a Q factor of the ultrasonic transducer at a predetermined temperature;
a temperature detector; and
a determiner to determine an anomaly of the ultrasonic transducer based on a temperature detected by the temperature detector, the Q factor stored in the storage, and the Q factor detected by the Q-factor detector.

6. The ultrasonic apparatus according to claim 5, wherein
the temperature detector includes:
a capacitance detector to detect a capacitance of the ultrasonic transducer;
a capacitance storage to store a capacitance of the ultrasonic transducer at the predetermined temperature; and
a temperature estimator to estimate a temperature based on the capacitance detected by the capacitance detector and the capacitance stored by the capacitance storage.

7. The ultrasonic apparatus according to claim 5, wherein the temperature detector includes a thermistor.

8. The ultrasonic apparatus according to claim 5, wherein
the ultrasonic transducer includes a piezoelectric element, a case, a sound absorber, and terminals; and
the case has a cylindrical or substantially cylindrical shape with a bottom.

9. An ultrasonic apparatus comprising:
an ultrasonic transducer;
a driving circuit to cause the ultrasonic transducer to transmit sonic waves;
a receiving circuit to receive sonic waves received by the ultrasonic transducer;
a frequency detector to detect a resonant frequency of the ultrasonic transducer;
a first storage to store a resonant frequency of the ultrasonic transducer at a predetermined temperature;
a Q-factor detector to detect a Q factor of the ultrasonic transducer;
a second storage to store a Q factor of the ultrasonic transducer at the predetermined temperature;
a temperature detector; and
a determiner to determine an anomaly of the ultrasonic transducer based on a temperature detected by the temperature detector, the resonant frequency stored in the first storage, the resonant frequency detected by the frequency detector, the Q factor stored in the second storage, and the Q factor detected by the Q-factor detector.

10. The ultrasonic apparatus according to claim 9, further comprising:
a resonant frequency estimator to estimate a resonant frequency at the temperature detected by the temperature detector, based on the resonant frequency stored in the first storage; and
a Q-factor estimator to estimate a Q factor at the temperature detected by the temperature detector, based on the Q factor stored in the second storage; wherein
the determiner includes:
a first determination processor to determine whether the resonant frequency detected by the frequency detector is normal, based on the resonant frequency estimated by the resonant frequency estimator; and
a second determination processor to determine whether the Q factor detected by the Q-factor detector is normal, based on the Q factor estimated by the Q-factor estimator.

11. The ultrasonic apparatus according to claim 9, further comprising:
a resonant frequency estimator to estimate a resonant frequency at the temperature detected by the temperature detector, based on the resonant frequency stored in the first storage; and
a Q-factor estimator to estimate a Q factor at the temperature detected by the temperature detector, based on the Q factor stored in the second storage; wherein
the determiner determines whether the ultrasonic transducer is normal, based on a combination of the resonant frequency estimated by the resonant frequency estimator and the Q factor estimated by the Q-factor estimator.

12. The ultrasonic apparatus according to claim 9, wherein
the temperature detector includes:
a capacitance detector to detect a capacitance of the ultrasonic transducer;
a capacitance storage to store a capacitance of the ultrasonic transducer at the predetermined temperature; and
a temperature estimator to estimate a temperature based on the capacitance detected by the capacitance detector and the capacitance stored by the capacitance storage.

13. The ultrasonic apparatus according to claim 9, wherein the temperature detector includes a thermistor.

14. The ultrasonic apparatus according to claim 9, wherein
the ultrasonic transducer includes a piezoelectric element, a case, a sound absorber, and terminals; and
the case has a cylindrical or substantially cylindrical shape with a bottom.

15. An ultrasonic apparatus comprising:
an ultrasonic transducer;
a driving circuit to cause the ultrasonic transducer to transmit sonic waves;
a receiving circuit to receive sonic waves received by the ultrasonic transducer;
a Q-factor detector to detect a Q factor of the ultrasonic transducer;
a storage to store a Q factor of the ultrasonic transducer at a predetermined temperature;
a capacitance detector to detect a capacitance of the ultrasonic transducer;
a capacitance storage to store a capacitance of the ultrasonic transducer at the predetermined temperature; and
a determiner to determine an anomaly of the ultrasonic transducer based on the capacitance detected by the capacitance detector, the Q factor stored in the storage, and the Q factor detected by the Q-factor detector.

16. The ultrasonic apparatus according to claim 15, wherein
the ultrasonic transducer includes a piezoelectric element, a case, a sound absorber, and terminals; and
the case has a cylindrical or substantially cylindrical shape with a bottom.

17. An ultrasonic apparatus comprising:
an ultrasonic transducer;
a driving circuit to cause the ultrasonic transducer to transmit sonic waves;
a receiving circuit to receive sonic waves received by the ultrasonic transducer;
a frequency detector to detect a resonant frequency of the ultrasonic transducer;
a storage to store a resonant frequency of the ultrasonic transducer at a predetermined temperature;
a capacitance detector to detect a capacitance of the ultrasonic transducer;
a capacitance storage to store a capacitance of the ultrasonic transducer at the predetermined temperature; and
a determiner to determine an anomaly of the ultrasonic transducer based on the capacitance detected by the capacitance detector, the resonant frequency stored in the storage, and the resonant frequency detected by the frequency detector.

18. The ultrasonic apparatus according to claim 17, wherein
the ultrasonic transducer includes a piezoelectric element, a case, a sound absorber, and terminals; and
the case has a cylindrical or substantially cylindrical shape with a bottom.
